(19) United States
(12) Patent Application Publication
(10) Pub. No.: US 2006/0178159 A1
(43) Pub. Date: Aug. 10, 2006

(54) Voice activated push-to-talk device and method of use

(76) Inventors: Don Timms, San Diego, CA (US); Refael Bar, San Diego, CA (US)

Correspondence Address: KYOCERA WIRELESS CORP., P.O. BOX 928289, SAN DIEGO, CA, 92192-8289, US

(21) Appl. No.: 11/053,207

(22) Filed: Feb. 7, 2005

(51) Int. Cl. H04B 7/00

(52) U.S. Cl. 455/518; 455/519

(57) ABSTRACT

An push-to-talk wireless communication device and method of facilitating a push-to-talk call are disclosed. The wireless communication device includes a voice recognition module that allows a user to establish and carry out a push-to-talk call through voice commands. The voice recognition module facilitates a push to talk call by establishing a push-to-talk call in response to a voice command. During the call, the voice recognition module identifies predetermined code words from the audio stream and manages the push-to-talk call functions accordingly.

### FIELD OF THE INVENTION

The present invention generally relates to wireless communications and more specifically relates to facilitating push-to-talk communication between wireless communication devices.

### BACKGROUND OF THE INVENTION

Conventional systems and methods for managing push-to-talk (“PTT”) communications over a wireless communication network require a user make many button presses in connection with managing the user's presence and availability for PTT communications and in connection with establishing and carrying out a PTT call. Additionally, a user must interact with the user interface, including both the display screen and the keyboard/buttons on the wireless communication device. These conventional systems and methods present severe disadvantages in situations where a user needs to operate the wireless communication device in a hands free mode, for example when driving an automobile.

The market for PTT wireless communication devices has therefore presented to the wireless communication industry a specific need for a safer hands free PTT capability. Meeting this need, however, presents significant challenges due to the inherent interaction that is required in “push”-to-talk communications. Therefore, what is needed is a system and method that facilitates hands free PTT communications between wireless communication devices.

### SUMMARY OF THE INVENTION

Accordingly, a hands free push-to-talk wireless communication device and method of facilitating a hands free push-to-talk call are provided. The wireless communication device includes a voice recognition module that allows a user to establish and carry out a push-to-talk call through voice commands. The voice recognition module facilitates a push to talk call by establishing a push-to-talk call in response to a voice command and during the call identifying predetermined code words from the audio stream and carrying out those push-to-talk call functions accordingly.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a network diagram illustrating an example wireless communication system configured to facilitate push-to-talk calls according to an embodiment of the present invention;

FIG. 2 is a block diagram illustrating an example wireless communication device according to an embodiment of the present invention;

FIG. 3 is a flow diagram illustrating an example process for establishing a push-to-talk call through voice activation;

FIG. 4 is a flow diagram illustrating an example process for facilitating an established push-to-talk call through voice activation;

FIG. 5 is a block diagram illustrating an exemplary wireless communication device that may be used in connection with the various embodiments described herein; and

FIG. 6 is a block diagram illustrating an exemplary computer system as may be used in connection with various embodiments described herein.

### DETAILED DESCRIPTION OF THE INVENTION

Certain embodiments as disclosed herein provide for a wireless communication device capable of establishing and carrying out push-to-talk (“PTT”) calls through voice activation. For example, one method as disclosed herein allows for the user of a PTT enabled wireless communication device to provide a voice command that causes the wireless communication device to establish a PTT call. Furthermore, during the call the user can provide voice commands that control the PTT communication session.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

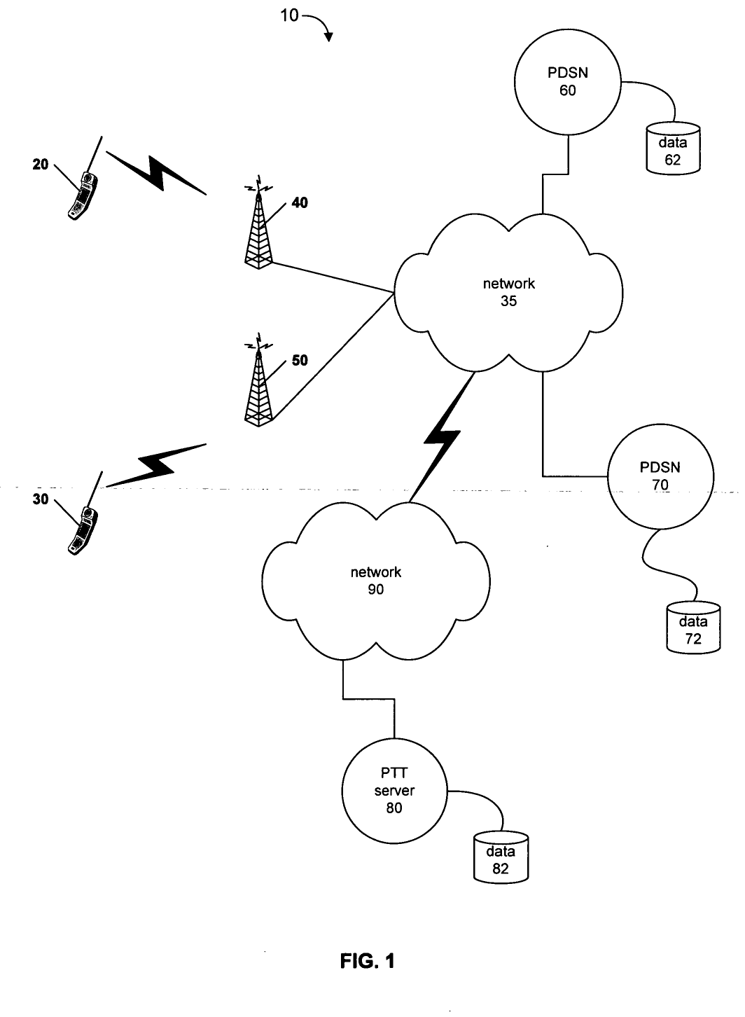

FIG. 1 is a network diagram illustrating an example wireless communication system 10 configured to facilitate push-to-talk calls. The system 10 comprises a plurality of wireless communication devices (also referred to as “wireless devices” and “handsets”) such as handsets 20 and 30. The handsets are communicatively coupled with a wireless communication network 35 via a plurality of base stations such as base stations 40 and 50. Also connected to the wireless communication network 35 are a plurality of packet data service nodes (“PDSN”) such as PDSNs 60 and 70. Each PDSN preferably is configured with a data storage area such as data storage areas 62 and 72.

The wireless communication network 35 can also be communicatively coupled with other communication networks such as network 90. In one embodiment, wireless communication network 35 is a code division multiple access 2000 (“CDMA2000”) network, the specification for which is published by the 3rd Generation Partnership Project 2 (“3GPP2”), which is incorporated herein by reference in its entirety. For example, wireless communication network 35 may be a CDMA2000 Release A network. Network 90 can be any of a large variety of networks such as a circuit switched telephone network or a packet data network such as the Internet. In the illustrated embodiment, a PTT server 80 is communicatively coupled with the PDSNs and the handsets via network 90. Alternatively, the PTT server 80 can be part of or connected directly to the wireless communication network 35. PTT server 80 is configured with a data storage area 82.

As will be understood by those skilled in the art, packet data communications over the wireless communication network 35 are routed throughout the network and beyond (e.g., to network 90) by the plurality of PDSNs such as PDSN 60 and PDSN 70. In one embodiment, PTT calls are packet data communications that use voice over internet protocol (“VoIP”) technology to carry voice between handsets as packet data. Alternative embodiments may employ alternative mechanisms to carry out a PTT call. All such mechanisms fall within the scope and spirit of the present invention.

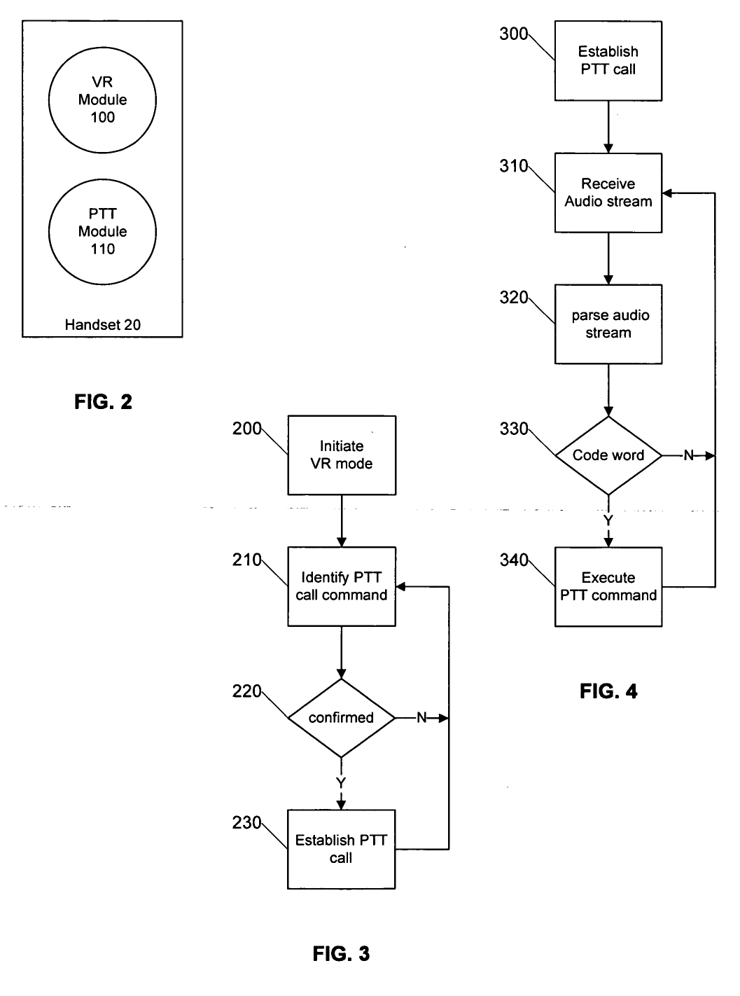

FIG. 2 is a block diagram illustrating an example wireless communication device 20 according to an embodiment of the present invention. In the illustrated embodiment, the handset 20 comprises a voice recognition (“VR”) module 100 and a PTT module 110. The VR module 100 is configured to identify audio commands received in the audio channel from the microphone and execute those commands. In one embodiment, the VR module 100 may be configured to prompt the user for confirmation prior to the execution of all commands or a subset of the commands. Advantageously, the VR module 100 can be capable of self training. In one embodiment, the VR module 100 may employ a listening algorithm that consumes low power. Additionally, the VR module 100 can be trained to learn the universe of PTT related commands. For example, a user may train the VR module 100 to understand all of the commands that the user may enter through interaction with the user interface such as group management (adding to groups, deleting groups, etc.) and user preferences (setting user availability, setting user presence, etc.).

The VR module 100 is communicatively coupled with the PTT module 110 so that when PTT related commands are identified by the VR module 100, those commands can be passed to the PTT module 110 for execution. The PTT module 110 is configured to establish PTT calls that are initiated by the handset or received by the handset. The PTT module 110 is also configured to manage active PTT calls and manage PTT presence information on the wireless communication network (not shown). PTT presence information is generally maintained by the wireless communication network to provide information about the handsets that are currently available for PTT communication.

FIG. 3 is a flow diagram illustrating an example process for establishing a PTT call through voice activation. Initially, in step 200, the voice recognition mode on the handset is initiated. For example, voice recognition mode can be initiated by launching the VR module that was previously described with respect to FIG. 2. In one embodiment, initiation of the VR mode may be carried out by the user selecting a specific command through the user interface. For example, the user may scroll through the menu system and make a selection to initiate the VR mode. Alternatively, the VR mode may be initiated by the press of a button or a combination of buttons. Other methods to initiate the VR mode may also be employed.

Once the VR mode has been initiated, the VR module proceeds to listen to incoming audio from the audio channel that is received by the microphone. This audio is parsed by the VR module and the parsed audio segments are examined to determine if a predetermined command has been issued. In one embodiment a PTT call command is one of the predetermined commands that the VR module is capable of identifying. For example, a user may set up his/her personal VR system to identify the word CALL as the command to initiate a voice call. In such an embodiment, the same user may also set up his/her personal VR system to identify the word TALK as the command to initiate a PTT call. In alternative embodiments, various audio segments may be employed as the PTT call command.

Accordingly, in step 210, the VR module identifies the PTT call command from the audio channel. In one embodiment, the VR module may request a confirmation in step 220 from the user that a PTT call command has been issued. This request may take the form of an audio signal such as a beep, a double beep, a customized audio segment, or synthesized speech.

If the user confirms that a PTT command has been issued, or if no such confirmation is required, the VR module next establishes a PTT call as shown in step 230. In one embodiment, the VR module may pass a command to a PTT module, such as the PTT module previously described with respect to FIG. 2, to cause the PTT module to initiate the PTT call.

FIG. 4 is a flow diagram illustrating an example process for facilitating an established PTT call through voice activation. Initially, in step 300, the PTT call is established, for example by the process previously described with respect to FIG. 3. Once the PTT call is established, the VR module, such as the VR module previously described with respect to FIG. 2, begins to receive the audio stream, for example from the audio channel that is fed by the microphone on the handset. In one embodiment, the VR module continuously receives audio from the audio channel.

Next, in step 320, the VR module parses the audio stream. The parsing may be carried out by procedures that break the audio stream into audio segments pursuant to a segmentation algorithm. For example, when a certain decibel level identified as no sound is met for a certain period of time, then a break in the audio stream is identified, where two consecutive breaks in the audio stream define either an audio segment or a no-audio segment. Audio segments can then be processed by the VR module to determine if they correlate to a predetermined audio command. The general operation of a VR module will be well understood by one having skill in the art.

With respect to the established PTT call, the VR module can be dynamically trained or configured to provide PTT specific commands to a PTT module such as the PTT module previously described with respect to FIG. 2. The VR module can also be trained for other PTT related commands such as commands related to adding to groups, setting user preferences and the like. In step 330, the VR module analyzes audio segments that have been parsed from the audio stream to determine if an audio segment is a predefined PTT code word. If an audio segment is not a code word, the VR module continues parsing the received audio stream and analyzing parsed audio segments. If, however, an audio segment is identified as a PTT code word, the VR module executes the PTT command. In one embodiment, the VR module sends a signal to the PTT module to cause the PTT module to execute the particular PTT command. After execution of the PTT command, the VR module continues to receive, parse, and analyze the audio stream for PTT related code words.

### Example Embodiment

In an example embodiment, a voice enabled PTT call may proceed in the following way. The VR module is activated by the user of the handset. The user speaks “TALK_JOE” into the microphone on the handset. The VR module receiving the audio stream from the microphone parses the audio segment TALK and determines that it is a PTT code word corresponding to the initiate PTT call command. The VR module additionally parses the audio segment JOE from the audio stream and determines that the JOE audio segment corresponds to the phone book entry on the handset for Joe Smith. The VR module obtains the necessary information for Joe Smith from the phone book entry and provides the PTT module with a communication instructing the PTT module to initiate a PTT call to Joe Smith. The PTT module then establishes the PTT call with Joe Smith.

In one embodiment, establishing the PTT call with Joe Smith causes an audible beep or chirp sound to be played through a speaker on the handset to indicate to the user that the call has been established. Alternative indicators may also be employed such as vibrating the handset, illuminating a portion of the handset (e.g., LED or display), or a different type of audio (e.g., synthesized speech).

Once the call has been established, the initiating user speaks into the phone without the need to depress any button or buttons during the speak time. When the initiating user is through speaking, the user speaks a code word that is received by the VR module. For example, the code word for when a user is finished speaking may be “OVER” or something similar.

In one embodiment, the VR module is configured to distinguish between spoken words that are used as a code word or are part of conversational speech. Continuing the same example above, the user may speak the word “OVER” as part of the conversation and then subsequently speak the work “OVER” again as a code word. The VR module is advantageously trained to differentiate between the different contextual uses of the word “OVER.” For example, the VR module may be trained to recognize a code word that is preceded by a certain amount of quiet input or followed by a certain amount of quiet input, or both. In such an embodiment, the conversational use of the word “OVER” would be either preceded or followed by (or both) other words and other sounds that are part of the conversational speech. When the user desires to use the code word “OVER” the user can pause for a predetermined amount of time before or after speaking the code word. Alternatively, the user may pause for a predetermined amount of time both before and after speaking the code word.

In alternative embodiments, the VR module may be sophisticated enough to differentiate between spoken code words and conversational use of the code word based on other factors such as the length of time during which the code word is spoken, the decibel level of the spoken code word, the enunciation of the code word, and other factors that allow the spoken code word to be differentiated from a conversational use of the code word.

Code words such as the initiate call code word, the end speaking code word, and others can be predetermined and dynamically learned by the VR module. Advantageously, different code words may be employed by different users for the same function. With respect to the PTT functionality, code words can be assigned to all off the various PTT functions including (but not limited to): initiate PTT call; begin speaking; end speaking; end PTT call; set presence, set availability, and group management, just to name a few. Other typical VR module functions such as phone book entry lookups can also be employed during PTT calls.

When the initiating user has finished speaking, the VR module receives the code word and instructs the PTT module to notify the recipient that the initiating user is finished speaking. The recipient may then proceed to speak in the normal course and when finished, the initiating user's handset receives a notice that the recipient is finished speaking. This notice can be provided to the initiating user through an audible beep or other type of signal. The PTT communication volley may then proceed until the conversation is completed and then the PTT call may be terminated. For example, the initiating can speak the words “END TALK” and those words are received by the VR module and an instruction is sent from the VR module to the PTT module to terminate the PTT call. In this fashion, a voice controlled PTT call can be established and carried out.

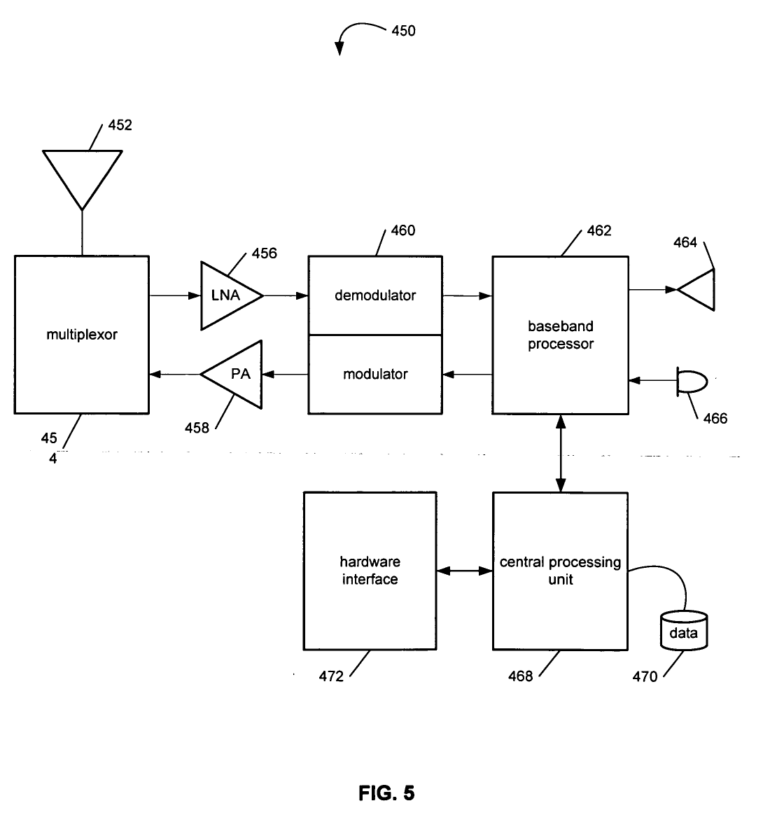

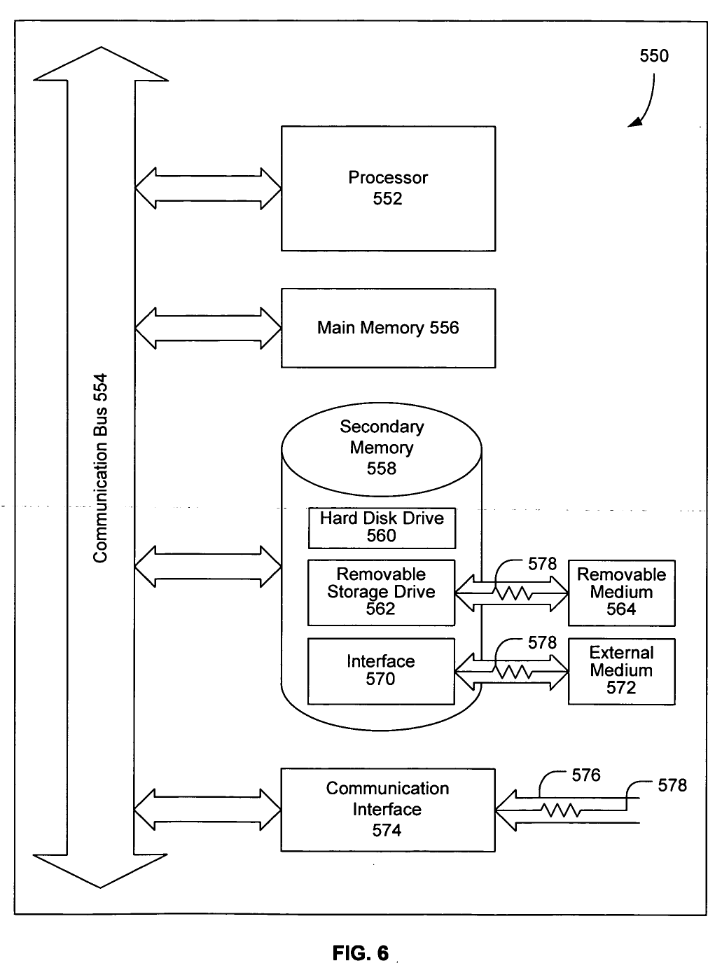

FIG. 5 is a block diagram illustrating an exemplary wireless communication device 450 that may be used in connection with the various embodiments described herein. For example, the wireless communication device 450 may be used in conjunction with a PTT enabled handset 20 or 30 as previously described with respect to FIGS. 1 and 2. However, other wireless communication devices and/or architectures may also be used, as will be clear to those skilled in the art.

In the illustrated embodiment, wireless communication device 450 comprises an antenna 452, a multiplexor 454, a low noise amplifier (“LNA”) 456, a power amplifier (“PA”) 458, a modulation circuit 460, a baseband processor 462, a speaker 464, a microphone 466, a central processing unit (“CPU”) 468, a data storage area 470, and a hardware interface 472. In the wireless communication device 450, radio frequency (“RF”) signals are transmitted and received by antenna 452. Multiplexor 454 acts as a switch, coupling antenna 452 between the transmit and receive signal paths. In the receive path, received RF signals are coupled from a multiplexor 454 to LNA 456. LNA 456 amplifies the received RF signal and couples the amplified signal to a demodulation portion of the modulation circuit 460.

Typically modulation circuit 460 will combine a demodulator and modulator in one integrated circuit (“IC”). The demodulator and modulator can also be separate components. The demodulator strips away the RF carrier signal leaving a base-band receive audio signal, which is sent from the demodulator output to the base-band processor 462.

If the base-band receive audio signal contains audio information, then base-band processor 462 decodes the signal and converts it to an analog signal. Then the signal is amplified and sent to the speaker 464. The base-band processor 462 also receives analog audio signals from the microphone 466. These analog audio signals are converted to digital signals and encoded by the base-band processor 462. The base-band processor 462 also codes the digital signals for transmission and generates a base-band transmit audio signal that is routed to the modulator portion of modulation circuit 460. The modulator mixes the base-band transmit audio signal with an RF carrier signal generating an RF transmit signal that is routed to the power amplifier 458. The power amplifier 458 amplifies the RF transmit signal and routes it to the multiplexor 454 where the signal is switched to the antenna port for transmission by antenna 452.

The baseband processor 462 is also communicatively coupled with the central processing unit 468. The central processing unit 468 has access to a data storage area 470. The central processing unit 468 is preferably configured to execute instructions (i.e., computer programs or software modules) that can be stored in the data storage area 470. Computer programs or software modules can also be received from the baseband processor 462 and stored in the data storage area 470 or executed upon receipt. Such computer programs, when executed, enable the wireless communication device 450 to perform the various functions of the present invention as previously described.

In this description, the term “computer readable medium” is used to refer to any media used to provide executable instructions (e.g., software and computer programs) to the wireless communication device 450 for execution by the central processing unit 468. Examples of these media include the data storage area 470, microphone 466 (via the baseband processor 462), antenna 452 (also via the baseband processor 462), and hardware interface 472. These computer readable mediums are means for providing executable code, programming instructions, and software to the wireless communication device 450. The executable code, programming instructions, and software, when executed by the central processing unit 468, preferably cause the central processing unit 468 to perform the inventive features and functions previously described herein.

The central processing unit is also preferably configured to receive notifications from the hardware interface 472 when new devices are detected by the hardware interface. Hardware interface 472 can be a combination electromechanical detector with controlling software that communicates with the CPU 468 and interacts with new devices.

FIG. 6 is a block diagram illustrating an exemplary computer system 550 that may be used in connection with the various embodiments described herein. For example, the computer system 550 may be used in conjunction with a PDSN or PTT server as previously described with respect to FIG. 1. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, a multi-media card (“MMC”) or other solid state storage device, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

From the above description of exemplary embodiments of the invention, it is manifest that various techniques can be used for implementing the concepts of the present invention without departing from its scope. Moreover, while the invention has been described with specific reference to certain embodiments, a person of ordinary skill in the art would recognize that changes could be made in form and detail without departing from the spirit and the scope of the invention. The described exemplary embodiments are to be considered in all respects as illustrative and not restrictive. It should also be understood that the invention is not limited to the particular exemplary embodiments described herein, but is capable of many rearrangements, modifications, and substitutions without departing from the scope of the invention.

What is claimed is:

1. A wireless communication device for facilitating a voice controlled push-to-talk call, comprising:
a push-to-talk module configured to establish a push-to-talk call, manage an active push-to-talk call, and terminate an established push-to-talk call; and
a voice recognition module configured to receive an audio segment, parse the audio segment to identify a voice command, analyze the voice command to determine a push-to-talk command, and instruct the push-to-talk module to execute the push-to-talk command.

2. The wireless communication device of claim 1, wherein the push-to-talk command is an initiate call push-to-talk command.

3. The wireless communication device of claim 1, wherein the voice recognition module is further configured to receive an audio segment during an active push-to-talk call, parse the audio segment to identify a voice command, analyze the voice command to determine a push-to-talk command and instruct the push-to-talk module to execute the push-to-talk command.

4. The wireless communication device of claim 3, wherein the push-to-talk command is a begin speaking push-to-talk command.

5. The wireless communication device of claim 3, wherein the push-to-talk command is an end speaking push-to-talk command.

6. The wireless communication device of claim 3, wherein the push-to-talk command is a set presence push-to-talk command.

7. The wireless communication device of claim 3, wherein the push-to-talk command is a set availability push-to-talk command.

8. The wireless communication device of claim 3, wherein the push-to-talk command is a terminate call push-to-talk command.

9. The wireless communication device of claim 3, wherein the voice recognition module is further configured to distinguish between a spoken voice command and a conversational use of the voice command.

10. A method for facilitating a voice controlled push-to-talk call on a wireless communication device, comprising:
initiating a voice recognition mode on a wireless communication device;
receiving an audio segment;
parsing the audio segment to determine a voice command;
identifying the voice command as a push-to-talk command; and
executing the push-to-talk command.

11. The method of claim 10, wherein the push-to-talk command is a set presence push-to-talk command and wherein the executing step comprises modifying a current push-to-talk presence setting for a user.

12. The method of claim 10, wherein the push-to-talk command is a set availability push-to-talk command and wherein the executing step comprises modifying a current push-to-talk availability setting for a user.

13. The method of claim 10, wherein the push-to-talk command is an initiate call push-to-talk command and wherein the executing step comprises establishing a push-to-talk call in response to the push-to-talk command.

14. The method of claim 13, further comprising:
receiving a second audio segment during the established push-to-talk call;
parsing the second audio segment to determine a second voice command;
identifying the second voice command as a second push-to-talk call command; and
executing the second push-to-talk command.

15. The method of claim 14, wherein the second push-to-talk command is a begin speaking push-to-talk command.

16. The method of claim 14, wherein the second push-to-talk command is an end speaking push-to-talk command.

17. The method of claim 14, wherein the parsing step further comprises distinguishing between a spoken voice command and a conversational use of the spoken voice command in the second audio segment.

18. A computer readable medium having stored thereon one or more sequences of instructions for causing one or more microprocessors to perform the steps for facilitating a voice controlled push-to-talk call on a wireless communication device, the steps comprising:
initiating a voice recognition mode on a wireless communication device;
receiving an audio segment;
parsing the audio segment to determine a voice command;
identifying the voice command as a push-to-talk command; and
executing the push-to-talk command.

19. The computer readable medium of claim 18, wherein the push-to-talk command is a set presence push-to-talk command and wherein the executing step comprises modifying a current push-to-talk presence setting for a user.

20. The computer readable medium of claim 18, wherein the push-to-talk command is a set availability push-to-talk command and wherein the executing step comprises modifying a current push-to-talk availability setting for a user.

21. The computer readable medium of claim 18, wherein the push-to-talk command is an initiate call push-to-talk command and wherein the executing step comprises establishing a push-to-talk call in response to the push-to-talk command.

22. The computer readable medium of claim 21, wherein the steps further comprise:
receiving a second audio segment during the established push-to-talk call;
parsing the second audio segment to determine a second voice command;
identifying the second voice command as a second push-to-talk call command; and
executing the second push-to-talk command.

23. The computer readable medium of claim 22, wherein the second push-to-talk command is a begin speaking push-to-talk command.

24. The computer readable medium of claim 22, wherein the second push-to-talk command is an end speaking push-to-talk command.

25. The computer readable medium of claim 22, wherein the parsing step further comprises distinguishing between a spoken voice command and a conversational use of the spoken voice command in the second audio segment.
